(19) United States
(12) Patent Application Publication
(10) Pub. No.: US 2006/0256406 A1
(43) Pub. Date: Nov. 16, 2006

(54) Color wheel calibrating method, color wheel module and projection apparatus

(76) Inventors: Hung-Chieh Huang, Miao-Li County (TW); Chih-Heng Fan Chiang, Miao-Li County (TW)

Correspondence Address: J.C. Patents, Inc., Suite 250, 4 Venture, Irvine, CA, 92618, US

(21) Appl. No.: 11/411,399

(22) Filed: Apr. 25, 2006

(30) Foreign Application Priority Data
May 13, 2005 (TW) 94115508

(51) Int. Cl. H04N 1/46

(52) U.S. Cl. 358/512; 358/504

(57) ABSTRACT

A color wheel calibrating method being adapted for determining an optimum color wheel index of a color wheel of a projection apparatus is provided. The projection apparatus includes a light source, a control unit and a color wheel. The color wheel calibrating method includes the steps of: first, inputting a roughly estimated color wheel index to the control unit for controlling the rotation of the color wheel; measuring the luminance of the light beam emitted from the light source after passing through the color wheel and getting a testing waveform; comparing the testing waveform with an optimum waveform and adjusting the roughly estimated color wheel index till the testing waveform approaching the optimum waveform and thereby obtaining the optimum color wheel index.

### CROSS-REFERENCE TO RELATED APPLICATION

This application claims the priority benefit of Taiwan application serial no. 94115508, filed on May 13, 2005. All disclosure of the Taiwan application is incorporated herein by reference.

### BACKGROUND OF THE INVENTION

1. Field of the Invention

The present invention relates a color wheel calibrating method, a color wheel module and a projection apparatus; and particularly to a color wheel calibrating method, a color wheel module and a projection apparatus for accurately determining an optimum color wheel index.

2. Description of Related Art

Referring to FIGS. 1A and 1B, a conventional projection apparatus 100 comprises an optical engine 110 and a projection lens 120. The optical engine 110 comprises a light source 112, a color wheel 114, a control unit 116 and a digital micro-mirror device (DMD) 118. The light source 112 is adapted for providing a light beam 112a. The color wheel 114 is disposed between the DMD 118 and the light source 112 while the control unit 116 and the color wheel 114 are electrically connected with the DMD 118.

Further, the color wheel 114 comprises a red light filtering zone R, a green light filtering zone G and a blue light filtering zone B. The control unit 116 is adapted for controlling the rotation of the color wheel 114. After the light beam 112a provided by the light source 112 passing through the filtering zones of respectively red light, green light and blue light R, G, B, a red light, a green light and a blue light can be obtained thereby. The DMD 118 driven by the control unit 116 displays different statuses in accordance with the red light, green light and blue light for respectively converting the red light, green light and blue light into a red image light, a green image light and a blue image light. Then, the projection lens 120 projects the obtained red, green, and blue image lights onto a screen for forming a full color image.

According to the conventional technologies, a signal emitting device 117 is often equipped to the color wheel 114, wherein a signal detector 119 is usually disposed at a backside of the signal emitting device 117. The signal detector 119 is electrically connected with the control unit 116 for receiving a signal 117a emitted from the signal emitting device 117. The signal emitting device 117 rotates together with the color wheel 114. Each time the signal detector 119 receives the signal 117a emitted from the signal emitting device 117 indicates that the light beam 112a is exactly passing through one of dividing lines among the filtering zones R. G. B (for example, the dividing line between the red light filtering zone R and the green light filtering zone G).

However, because a deviation of the signal emitting device 117 when attaching to the color wheel 114 from its theoretical position is substantially inevitable, the control unit 116 can not compute exact timings of the light beam 112a passing through the filtering zones of red light, green light and blue light R, G, B for controlling the DMD 118. As a result, the color of the image projected by the projection apparatus 100 is not as expected. The conventional method for solving the above problem is to store a color wheel index in the control unit 116, by which the control unit 116 can compensate the timing differences between the color wheel 114 and the DMD 118 to solve the above problem and make the colors of the images conform expectations.

A conventional color wheel calibrating method generally includes the steps of: inputting a color wheel index to a control unit 116; an operator evaluating the appropriateness of the inputted color wheel index according to the colors of testing images displayed by the projection apparatus 100; if the colors of the testing images are not as good as the operator expected, adjusting the color wheel index till an optimum color wheel index is obtained.

The conventional color wheel calibrating method obtains an optimum color wheel index by an operators according to the colors of the testing images. However, different operators have different senses toward a same color, and different operators obtain different optimum color wheel indices. Thus, the product quality is unstable. Furthermore, it is difficult to correctly adjust the color wheel index according to the conventional color wheel calibrating method, which requires lengthy working hours and high production cost.

### SUMMARY OF THE INVENTION

An object of the present invention is to provide a color wheel calibrating method, being adapted for determining an optimum color wheel index.

Another object of the present invention is to provide a color wheel module, being adapted for determining an optimum color wheel index.

A further object of the present invention is to provide an projection apparatus, being adapted for determining an optimum color wheel index.

According to the above and other objects, the present invention provides a color wheel calibrating method, being adapted for determining an optimum color wheel index of a color wheel of a projection apparatus. The projection apparatus includes a light source, a control unit and a color wheel. The color wheel calibrating method includes the steps of: first, inputting a roughly estimated color wheel index to the control unit for controlling the rotation of the color wheel; measuring the luminance of the light beam emitted from the light source after passing through the color wheel and obtaining a testing waveform; then, comparing the testing waveform with an optimum waveform and adjusting the roughly estimated color wheel index till the testing waveform approaching the optimum waveform and thereby obtaining an optimum color wheel index.

The present invention also provides a color wheel module, being adapted for a projection apparatus. The projection apparatus includes a light source and a control unit, the light source being adapted for providing a light beam. The color wheel module includes a color wheel and an optical detector; the color wheel is secured oil a transmitting path of the light beam and electrically connected with the control unit, and the optical detector is secured behind the color wheel and electrically connected with the control unit. The optical detector is adapted for detecting the luminance of the light beam after passing through the color wheel.

The present invention also provides a projection apparatus, including an optical engine and a projection lens; the projection lens is secured behind the optical engine. The optical engine includes a light source, a color wheel module, a displaying device and a control unit. The color wheel module includes a color wheel and an optical detector. The light source is adapted for providing a light beam; the color wheel is secured on a transmitting path of the light beam; the optical detector is secured behind the color wheel; and the optical detector is adapted for detecting the luminance of the light beam after passing through the color wheel. Further, the displaying device is secured behind the optical detector, being adapted for converting the light beam into an image light; the control unit is electrically connected with the color wheel, the optical detector and the displaying device. Moreover, the projection lens is disposed on the transmitting path of the image light.

According to the present invention, an optical detector is employed for measuring the luminance of the light beam provided by the light source after passing through the color wheel and obtaining a testing waveform. By comparing the testing waveform with an optimum waveform, an optimum color wheel index can be obtained. Because comparison between waveforms is relatively simple and the compared result is more accurate, the optimum color wheel index obtained by different operators is likely to be more coherent. The stability of the product quality can be improved. Furthermore, the operators can adjust the color wheel index according to the waveforms, which both the working hours and the production cost are reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a structural diagram schematically illustrating a conventional projection apparatus.

FIG. 1B is a structural diagram schematically illustrating a color wheel according to FIG. 1A.

FIG. 2 is a flowchart illustrating the steps of a color wheel calibrating method according to an embodiment of the present invention.

FIG. 3A is a structural diagram illustrating a projection apparatus according to an embodiment of the present invention.

FIG. 3B is a structural diagram schematically illustrating a color wheel according to FIG. 3A.

FIG. 4A is a schematic diagram of a testing waveform.

FIG. 4B is a schematic diagram of an optimum waveform.

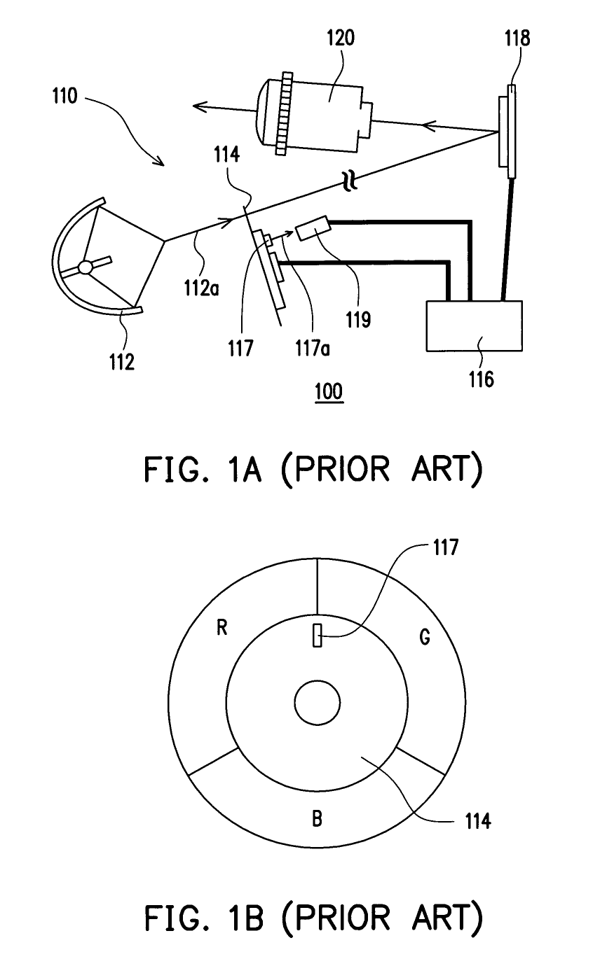

### DESCRIPTION OF THE EMBODIMENTS

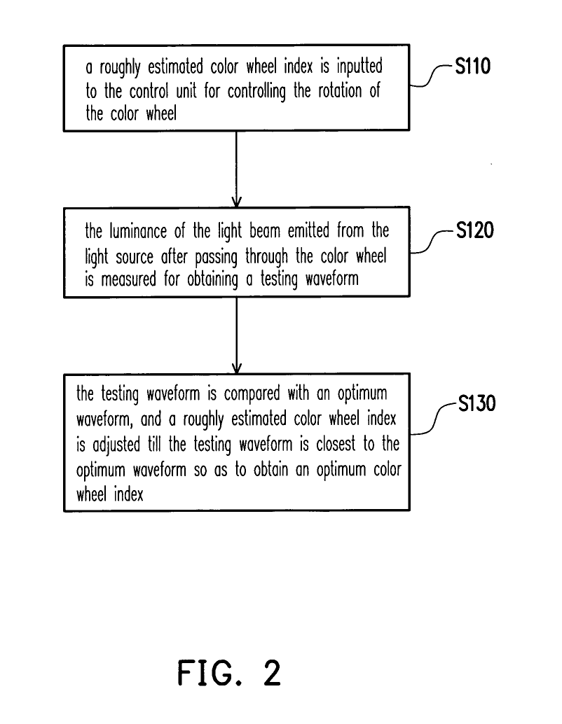

Referring to FIGS. 2, 3A, 3B, 4A and 4B, a color wheel calibrating method according to an embodiment of the invention is adapted for determining an optimum color wheel index of a color wheel 214a of a projection apparatus 200. The projection apparatus 200 includes a light source 212, a control unit 218 and the color wheel 214a. According to the embodiment, the color wheel calibrating method for determining the optimum color wheel index of the color wheel 214a includes the steps as below.

First, as shown in step S110, a roughly estimated color wheel index is inputted to the control unit 218 for controlling a rotation of the color wheel 214a. In detail, the projection apparatus 200 for example includes an adjusting interface. According to the embodiment, the adjusting interface can be operated by manpower for inputting the roughly estimated color wheel index to the control unit 218. However, the control unit 218 can also input the roughly estimated color wheel index by itself.

Then, as shown in step S120, a luminance of the light beam emitted from the light source 212 after passing through the color wheel 214a is measured for obtaining a testing waveform 70. In detail, according to an embodiment, an optical detector 214b for example is employed for detecting a luminance of a light beam 212a emitted from the light source 212 after passing through the color wheel 214a. The optical detector 214b is electrically connected with the control unit 218 and feeds the detected luminance back to the control unit 218.

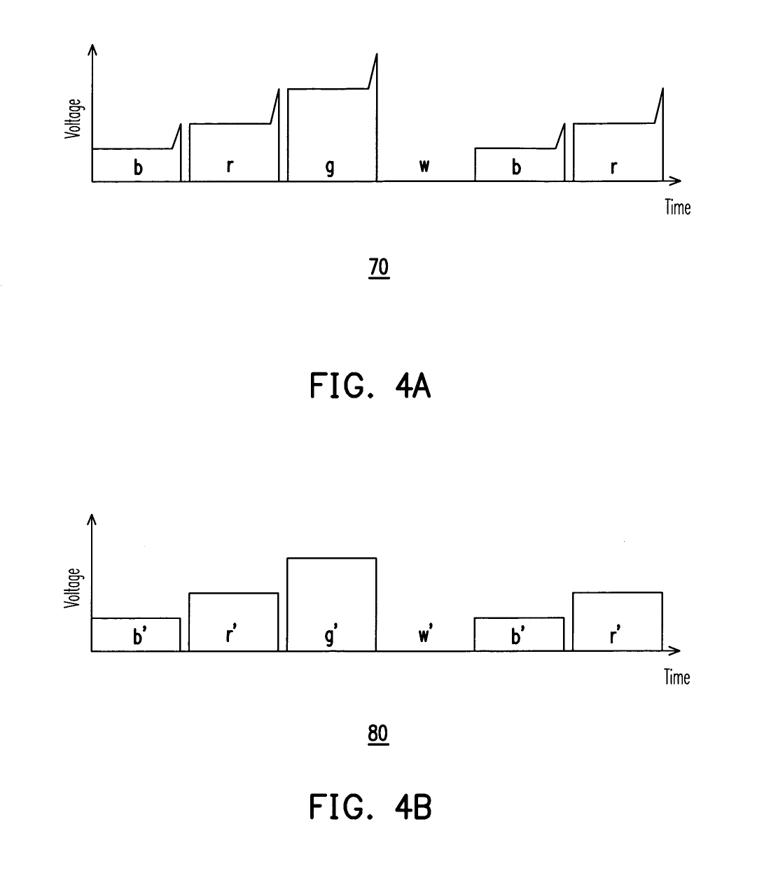

According to an embodiment, the color wheel 214a for example has a green light filtering zone G, a red light filtering zone R, a blue light filtering zone B and a white light filtering zone W for dividing the light beam 212a into a green light, a red light, a blue light and a white light. The waveforms g, r, b, w shown in FIG. 4A respectively represent the waveforms detected by the optical detector 214b at the time the control unit 218 recognized the light beam 212a being divided into green light, red light, blue light and white light.

Then, as shown in step S130, the testing waveform 70 is compared with an optimum waveform 80, and a roughly estimated color wheel index is adjusted till the testing waveform 70 approaching the optimum waveform 80 so as to obtain an optimum color wheel index. According to this embodiment, the method for comparing the testing waveform 70 with the optimum waveform 80 for example can be judging whether the testing waveform 70 is delayed or not. It can be known from the testing waveform 70 shown in FIG. 4A, the optical detector 214b detects a red light before the time of the blue light expired, a green light before the time of the red light expired, and a white light before the time of the green light expired. Such an unusual situation causes abnormal projection images. Therefore, the roughly estimated color wheel index inputted to the control unit 218 is adjusted till the testing waveform 70 approaching the optimum waveform 80. When the testing waveform 70 is closest or equal to the optimum waveform 80, the roughly estimated color wheel index inputted to the control unit 218 is the optimum color wheel index.

According to an embodiment of the invention, the method for comparing the testing waveform with the optimum waveform for example can be: the projection apparatus 200 outputting a testing waveform to a screen (not shown) or outputting the testing waveform to an oscillograph (not shown) which is electrically connected with a control unit and comparing by manpower. Furthermore, the method for adjusting the roughly estimated color wheel index can be: controlling the interface of the control unit 218 by manpower to adjust the roughly estimated color wheel index. Moreover, according to another aspect of the embodiment, the control unit 218 can compare the testing waveform 70 with the optimum waveform 80 by itself and adjust the roughly estimated color wheel index by itself.

The color wheel index calibrating method according to the embodiment determines whether the roughly estimated color wheel index inputted to the control unit 218 is an optimum color wheel index or not by comparing the testing waveform 70 with an optimum waveform 80. Because such a determination process is relatively simple and convenient, the optimum color wheel indices obtained by different operators are likely to be more accurate and coherent with each other, by which the stability of the product quality can be improved. Further, according to the testing waveform 70, the operators can determine how to adjust the roughly estimated color wheel index. The efficiency of determining the optimum color wheel index is improved and the production cost also is reduced accordingly. Also, according to the embodiment, the control unit 218 can find out the optimum color wheel index by itself, so that not only the time for determining the optimum color wheel index can be extremely saved to reduce the production cost, but also the accuracy of the optimum color wheel index can be improved.

It is to be noted that although the foregoing optical detector 214b is a device secured in the projection apparatus, the optical detector 214b can also be temporarily installed by an operator. After the optimum color wheel index has been determined, the optical detector 214b can be removed from the projection apparatus.

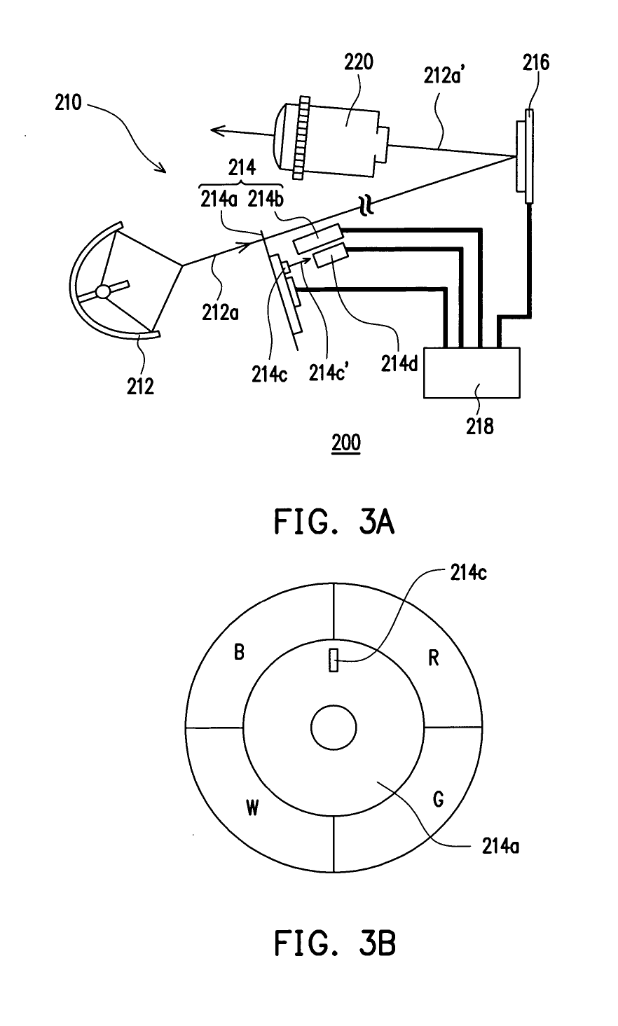

The projection apparatus 200 is illustrated in detail as follows. Referring to FIG. 3, according to an embodiment of the invention, a projection apparatus 200 includes an optical engine 210 and a projection lens 220. The projection lens 220 is secured behind the optical engine 210. The optical engine 210 includes a light source 212, a color wheel module 214, a displaying device 216 and a control unit 218. The color wheel module 214 includes a color wheel 214a and an optical detector 214b. The light source 212 is adapted for providing a light beam 212a; the color wheel 214a is secured on the transmitting path of the light beam 212a and the optical detector 214b is secured behind the color wheel 214a; the optical detector 214b is adapted for detecting the luminance of the light beam 212a after passing through the color wheel 214a. Further, the displaying device 216 is secured behind the optical detector 214b for converting the light beam 212a into an image light 212a′. The control unit 218 is electrically connected with the color wheel 214a, the optical detector 214b and the displaying device 216. Moreover, the projection lens 220 is disposed on the transmitting path of the image light 212a′.

According to the foregoing projection apparatus 200, the color wheel 214a for example has a plurality of light filtering zones (such as red light filtering zone R, green light filtering zone G, blue light filtering zone B and white light filtering zone W) for dividing the light beam 212a into multiple colors (such as red light, green light, blue light and white light). The color wheel module 214 for example further includes a signal emitting device 214c and a signal detector 214d; the signal emitting device 214c is secured on the color wheel 214a and the signal detector 214d is secured behind the color wheel 214a and electrically connected with the control unit 218. The signal emitting device 214c is adapted for emitting a signal 214c′ and the signal detector 214d is adapted for detecting the signals 214c′ emitted from the signal emitting device 214c. Each time the signal detector 214d receiving a signal 214c′ emitted from the signal emitting device 214c represents that the light beam 212a is passing through one of the dividing lines among the filtering zones R, G, B and W (for example, the dividing line between the red light filtering zone R and the white light filtering zone W) of the color wheel 214.

Furthermore, the control unit 218 drives the displaying device 216 according to the timings of the light beam 212a passing through the light filtering zones of the color wheel 214 to convert the light beams 212a into different image lights 212a′ with different colors. In addition, the image lights 212a′ with different colors is projected by the projection lens 220 onto a screen (not shown) to form a full color image.

Since the projection apparatus 200 has an optical detector 214b, in case of the optimum color wheel index has to be reset due to certain failure or other reasons, a customer service staff directly resets the optimum color wheel index according to the foregoing color wheel index calibrating method without spending time finding the original set value. Users set the optimum color wheel index by themselves according to the foregoing color wheel calibrating method so that the time and money for maintenance can be saved.

It should be noted that in the projection apparatus 200 according to the embodiment, the control unit 218 can also obtain the timings of the light beam 212a passing through the light filtering zones of the color wheel 214 according to the waveforms detected by the optical detectors 214b. Thus, the signal emitting device 214c and the signal detector 214d can be either included in the projection apparatus of the embodiment or not.

In summary, the color wheel calibrating method and the projection apparatus of the present invention has at least the advantages as below:
1. Because comparison between waveforms is relatively simple and the compared result is more accurate, the optimum color wheel index obtained by different operators is likely to be consistent, whereby the stability of the product quality can be improved.
2. The operators can determine how to adjust the color wheel index according to the testing waveforms, and therefore the working hours can be shortened and the production cost can be reduced.
3. According to an aspect of the embodiment, the control unit can find out the optimum color wheel index by itself, so that not only the time for determining the optimum color wheel index can be significantly saved, but also the accuracy of the optimum color wheel index can be improved.
4. A projection apparatus having an optical detector is convenient for the customer, service maintenance staff to reset the optimum color wheel index; even the users set the optimum color wheel index by themselves for saving the time and money spent on maintenance.

Other modifications and adaptations of the above-described preferred embodiments of the present invention are made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A color wheel calibrating method, adapted for determining an optimum color wheel index of a color wheel of a projection apparatus, the projection apparatus comprising a light source, a control unit and a color wheel, the color wheel calibrating method comprising the steps of:
inputting a roughly estimated color wheel index to the control unit for controlling a rotation of the color wheel;
measuring a luminance of a light beam emitted from the light source after passing through the color wheel and obtaining a testing waveform; and
comparing the testing waveform with an optimum waveform and adjusting the roughly estimated color wheel index till the testing waveform approaching the optimum waveform and thereby obtaining the optimum color wheel index.

2. The color wheel calibrating method according to claim 1, wherein the step of inputting the roughly estimated color wheel index to the control unit further comprises controlling an adjusting interface of the control unit to input the roughly estimated color wheel index by manpower.

3. The color wheel calibrating method according to claim 1, wherein the step of inputting the roughly estimated color wheel index to the control unit further comprises inputting the roughly estimated color wheel index by the control unit itself.

4. The color wheel calibrating method according to claim 1, wherein the method for measuring the luminance comprises employing an optical detector for detecting the luminance of the light beam.

5. The color wheel calibrating method according to claim 4, wherein the method for measuring the luminance further comprises feeding back the measured luminance to the control unit.

6. The color wheel calibrating method according to claim 1, wherein the method for comparing the testing waveform with the optimum waveform comprises judging whether the testing waveform is delayed or not.

7. The color wheel calibrating method according to claim 1, wherein the method for comparing the testing waveform with the optimum waveform comprises outputting the testing waveform by the projection apparatus to a screen and comparing by manpower.

8. The color wheel calibrating method according to claim 1, wherein the method for comparing the testing waveform with the optimum waveform comprises outputting the testing waveform to an oscillograph which is electrically connected to the control unit and comparing the testing waveform with the optimum waveform by manpower.

9. The color wheel calibrating method according to claim 1, wherein the method for comparing the testing waveform with the optimum waveform comprises comparing the testing waveform with the optimum waveform via the control unit.

10. The color wheel calibrating method according to claim 9, wherein the method for adjusting the roughly estimated color wheel index comprises adjusting the roughly estimated color wheel index via the control unit.

11. The color wheel calibrating method according to claim 1, wherein the method for adjusting the roughly estimated color wheel index comprises controlling an adjusting interface of the control unit by manpower to adjust the roughly estimated color wheel index.

12. A color wheel module, being adapted for a projection apparatus, the projection apparatus comprising a light source and a control unit, the light source being adapted for providing a light beam, the color wheel module comprising:
a color wheel, being secured on a transmitting path of the light beam and being electrically connected with the control unit; and
an optical detector, being secured behind the color wheel and being electrically connected with the control unit, wherein the optical detector is adapted for detecting the luminance of the light beam after passing through the color wheel.

13. The color wheel module according to claim 12, wherein the color wheel comprises a plurality of light filtering zones and the optical detector is adapted for detecting a luminance of the light beam after passing through the light filtering zones.

14. The color wheel module according to claim 12 further comprising:
a signal emitting device, being secured on the color wheel and adapted for emitting a signal; and
a signal detector, being secured behind the color wheel and electrically connected with the control unit, wherein the signal detector is adapted for detecting the signal emitted from the signal emitting device.

15. A projection apparatus, comprising:
an optical engine comprising:
a light source, being adapted for providing a light beam;
a color wheel module, comprising:
a color wheel, being secured on a transmitting path of the light beam; and
an optical detector, being secured behind the color wheel, wherein the optical detector is adapted for detecting a luminance of the light beam after passing through the color wheel;
a displaying device, being secured behind the optical detector, wherein the displaying device is adapted for converting the light beam into an image light; and
a control unit, being electrically connected with the color wheel, the optical detector and the displaying device; and
a projection lens, being disposed on a transmitting path of the image light.

16. The projection apparatus according to claim 15, wherein the color wheel comprises a plurality of light filtering zones and the optical detector is adapted for detecting the luminance of the light beam after passing through the light filtering zones.

17. The projection apparatus according to claim 15, wherein the color module further comprises:
a signal emitting device, being secured on the color wheel and adapted for emitting a signal; and
a signal detector, being secured behind the color wheel and electrically connected with the control unit, wherein the signal detector is adapted for detecting the signals emitted from the signal emitting device.
